(19) United States
(12) Patent Application Publication
(10) Pub. No.: US 2016/0102847 A1
(43) Pub. Date: Apr. 14, 2016

(54) LIGHTING DEVICE, DISPLAY DEVICE, AND TELEVISION RECEIVING DEVICE

(71) Applicant: Sharp Kabushiki Kaisha, Osaka (JP)

(72) Inventor: Akira GOTOU, Osaka (JP)

(73) Assignee: Sharp Kabushiki Kaisha, Osaka (JP)

(21) Appl. No.: 14/889,787

(22) PCT Filed: Feb. 25, 2014
(86) PCT No.: PCT/JP2014/054455

§ 371 Date: Nov. 6, 2015

(30) Foreign Application Priority Data
May 10, 2013 (JP) 2013-100290

(51) Int. Cl. F21V 19/00; H04N 5/64; G02F 1/1335; F21V 8/00; F21V 21/005; F21V 29/70

(52) U.S. Cl. CPC F21V 19/004; F21V 21/005; F21V 29/70; G02F 1/1336; G02B 6/0073; H04N 5/64

(57) ABSTRACT

An illumination device includes: a plurality of LED substrates having a rectangular plate shape, the plurality of LED substrates arranged in a row along a long side direction thereof, and each of the LED substrates having a plurality of LEDs on one surface thereof; and a heat-dissipating member abutting another surface of each of the LED substrates. A cutout portion is provided in each of the short sides, facing each other, of the LED substrates that are adjacent to each other. A fixing screw has a screw shaft that goes through the cutout portion from the mounting surface of the LED substrates and is fixed to the heat-dissipating member and a screw head that abuts the mounting surface of each of the LED substrates that are adjacent to each other.

### TECHNICAL FIELD

The present invention relates to an illumination device, a display device, and a television receiver.

### BACKGROUND ART

A liquid crystal display device such as a liquid crystal television separately requires a backlight device as an illumination device, because the display panel of the liquid crystal display device, a liquid crystal panel, does not emit light itself, for example. In a backlight device in this type of a liquid crystal display device, a case houses components such as light source substrates that mount light sources such as LEDs, and a heat-dissipating member for effectively dissipating heat generated near the light sources to the outside. After being taped to the surface of a heat-dissipating member or the case with double-sided tape or the like, the light source substrates are fixed to the heat-dissipating member, the case, and the like by having part of the substrates fastened by a fixing member such as a screw, for example. Patent Document 1 discloses a backlight device configured in a manner similar to above to fix the light source substrates to the heat-dissipating member, the case, and the like, for example.

### RELATED ART DOCUMENT

### Patent Document

Patent Document 1: Japanese Patent Application Laid-Open Publication No. 2012-237825

### Problems to be Solved by the Invention

A plurality of light source substrates disposed in parallel can be housed inside a case of a large display module such as a large television receiver. In such a configuration, in which the plurality of light source substrates are disposed in parallel, if a through-hole for fastening a fixing member is provided in each edge of adjacent light source substrates, space for providing the through-hole needs to be secured in the region between the edge of the light source substrate and the light source disposed near the edge in each light source substrate. Because of this, the distance between the light sources over the gap between the adjacent light source substrates can increase. As a result, the brightness in the gap between adjacent light source substrates can decrease.

### SUMMARY OF THE INVENTION

The technology disclosed in the present specification was made in view of the above-mentioned problems. The present specification aims to provide a technology capable of preventing or mitigating the reduction in brightness in the gap between the adjacent light source substrates using a simple configuration.

### Means for Solving the Problems

The technology disclosed in the present specification relates to an illumination device including: light sources; a plurality of light source substrates having a rectangular plate shape, the light source substrates being arranged in a row along a long side direction thereof, and each of the light source substrates having a plurality of light sources on one surface thereof; an abutting member abutting another surface of each of the light source substrates; and a fixing member that fixes the light source substrates to the abutting member, wherein, for at least one of the light source substrates, a cutout portion is provided in at least one of short sides, facing each other, of the light source substrates that are adjacent to each other, and wherein a fixing member has a portion that goes though the cutout portion from the one surface and that is fixed to the abutting member and another portion that abuts the one surface of each of the light source substrates that are adjacent to each other.

According to the illumination device described above, a portion of the fixing member is fixed to the abutting member through the cutout portion provided in at least one of the short sides, facing each other, of the light source substrates that are adjacent to each other, and another portion of the fixing member abuts the surface of each of the light source substrates that are adjacent to each other. Thus, the light source substrates that are adjacent to each other can be fixed to the abutting member with just one fixing member. For this reason, compared to when disposing the fixing member near the short edges of each of the light source substrates that are adjacent to each other, the space needed to dispose the fixing members can be reduced, for example. As a result, in the illumination device described above, adequate space for disposing the light sources around the gap between the light source substrates that are adjacent to each other can be secured, and the reduction in brightness in the gap between the light source substrates that are adjacent to each other can be either prevented or mitigated using a simple configuration.

The cutout portion may be provided in each of the short sides, facing each other, of the light source substrates that are adjacent to each other, and the two adjacent cutout portions may be symmetrical in shape and size about a gap between the light source substrates that are adjacent to each other.

According to this configuration, the forces applied by the fixing member to fix each of the light source substrates that are adjacent to each other become equal. In other words, the fixing member allows each of the light source substrates that are adjacent to each other to be held with equal force, without one side being held with greater force than the other.

The fixing member may abut an inner surface of the cutout portion.

According to this configuration, the fixing member can fix the position of the light source substrates to align with the surface direction of the abutting member.

The cutout portion may be provided in a plurality along a short side direction of the light source substrates, and the fixing member may be provided in a plurality to fix each of the light source substrates that are adjacent to each other to the abutting member.

According to this configuration, the light source substrates can be fixed to the abutting member more firmly by the plurality of the fixing members.

The fixing member may be a resin clip.

According to this configuration, the weight of the illumination device can be reduced compared to when the fixing members are made of metal such as screws.

The abutting member may be a heat-dissipating member having heat-dissipating characteristics.

According to this configuration, the heat generated near the light sources can be effectively dissipated to the outside via the light source substrates or the heat-dissipating member.

The abutting member may be a chassis, a part of which is a bottom plate.

According to this configuration, in an illumination device having light source substrates disposed on the bottom plate of the chassis, or in other words a direct-lit illumination device, the reduction in brightness in the gap between the adjacent light source substrates can be either prevented or mitigated.

The techniques disclosed in the present specification can be expressed as a display device including: the illumination device; and a display panel that performs display using light from the illumination device. A display device, wherein the display panel is a liquid crystal panel that uses liquid crystal, is also novel and useful. A television receiver that includes the display device is also novel and useful.

### Effects of the Invention

According to the technology disclosed in the present specification, the reduction in brightness in the gap between adjacent light source substrates can be either prevented or mitigated using a simple configuration.

### BRIEF DESCRIPTION OF THE DRAWINGS

FIG. 1 is an exploded perspective view of a television receiver TV according to Embodiment 1.

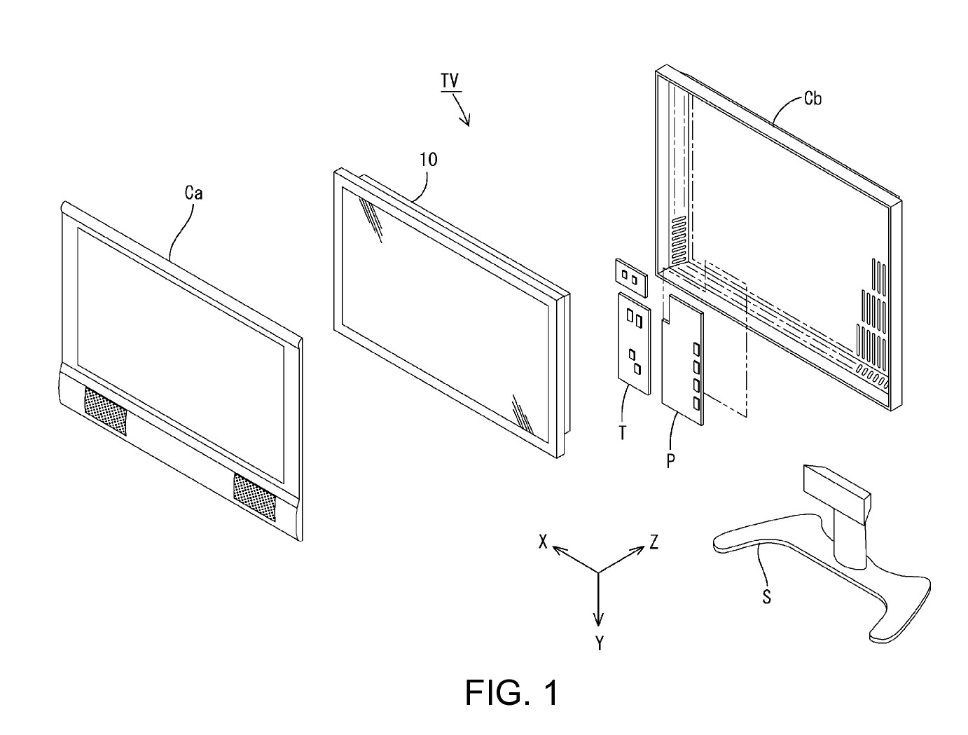

FIG. 2 is an exploded perspective view of a liquid crystal display device.

FIG. 3 is a cross-sectional view of a liquid crystal display device sliced at plane Y-Z.

FIG. 4 is a plan view of a backlight device.

FIG. 5 is an expanded plan view of the gap between adjacent LED substrates in FIG. 4.

FIG. 6 is an expanded front view of the gap between adjacent LED substrates before a fixing screw is inserted.

FIG. 7 is an expanded front view of the gap between adjacent LED substrates after a fixing screw is inserted.

FIG. 8 is an expanded front view of the gap between adjacent LED substrates before fixing screws are inserted in Embodiment 2.

FIG. 9 is an expanded front view of the gap between adjacent LED substrates after fixing screws are inserted in Embodiment 2.

FIG. 10 is an enlarged plan view of the gap between adjacent LED substrates in Embodiment 3.

FIG. 11 is an enlarged front view of the gap between adjacent LED substrates before a resin clip is inserted in Embodiment 3.

FIG. 12 is an enlarged front view of the gap between adjacent LED substrates after a resin clip is inserted in Embodiment 3.

FIG. 13 is an exploded perspective view of a liquid crystal display device according to Embodiment 4.

FIG. 14 is a plan view of a backlight device according to Embodiment 4.

FIG. 15 is an enlarged front view of the gap between adjacent LED substrates before a fixing screw is inserted according to Embodiment 5.

FIG. 16 is an enlarged front view of the gap between adjacent LED substrates after a fixing screw is inserted according to Embodiment 5.

FIG. 17 is an enlarged front view of the gap between adjacent LED substrates before a fixing screw is inserted according to Embodiment 6.

FIG. 18 is an enlarged front view of the gap between adjacent LED substrates after a fixing screw is inserted according to Embodiment 6.

### DETAILED DESCRIPTION OF EMBODIMENTS

### Embodiment 1

Embodiment 1 is described with reference to the drawings. In the present embodiment, a liquid crystal display device (one example of a display device) 10 is described as an example. Each of the drawings indicates an X axis, a Y axis, and a Z axis in a portion of the drawings, and each of the axes indicates the same direction for the respective drawings. The Y axis direction corresponds to the vertical direction, and the X axis direction corresponds to the horizontal direction. Unless otherwise noted, “up” and “down” in the description is based on the vertical direction.

A television receiver TV includes the liquid crystal display device 10, front and rear cabinets Ca and Cb that house the liquid crystal display device 10 therebetween, a power source P, a tuner T, and a stand S. The liquid crystal display device 10 has a horizontally-long quadrilateral shape as a whole and includes a liquid crystal panel 16, which is a display panel, and a backlight device (an example of an illumination device) 24, which is an external light source. These are integrally held together by a component such as a bezel 12 having a frame-like shape. In the liquid crystal display device 10, the liquid crystal panel 16 is assembled with the display surface capable of displaying an image facing the front side.

Next, the liquid crystal panel 16 is described. In the liquid crystal panel 16, a pair of transparent (having a high degree of light transmission characteristics) glass substrates are bonded together with a prescribed gap therebetween, and a liquid crystal layer (not shown) is sealed between the glass substrates. One of the glass substrates is provided with switching elements (such as TFTs) connected to source lines and gate lines that intersect each other, pixel electrodes connected to the switching elements, an alignment film, and the like. The other glass substrate is provided with color filters including respective colored portions of R (red), G (green), B (blue), and the like, which are in a prescribed arrangement, an opposite electrode, an alignment film, and the like. Of these, the source lines, the gate lines, the opposite electrode, and the like are supplied with image data and various control signals from a driver circuit substrate (not shown) necessary for displaying an image. Polarizing plates (not shown) are disposed on the respective outer sides of the glass substrates.

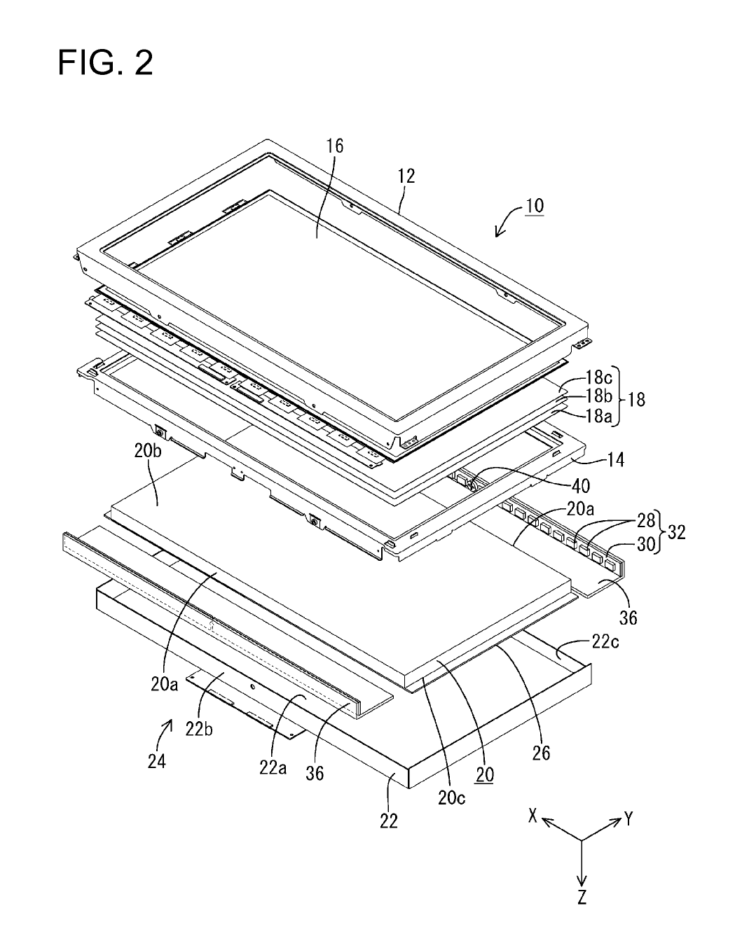

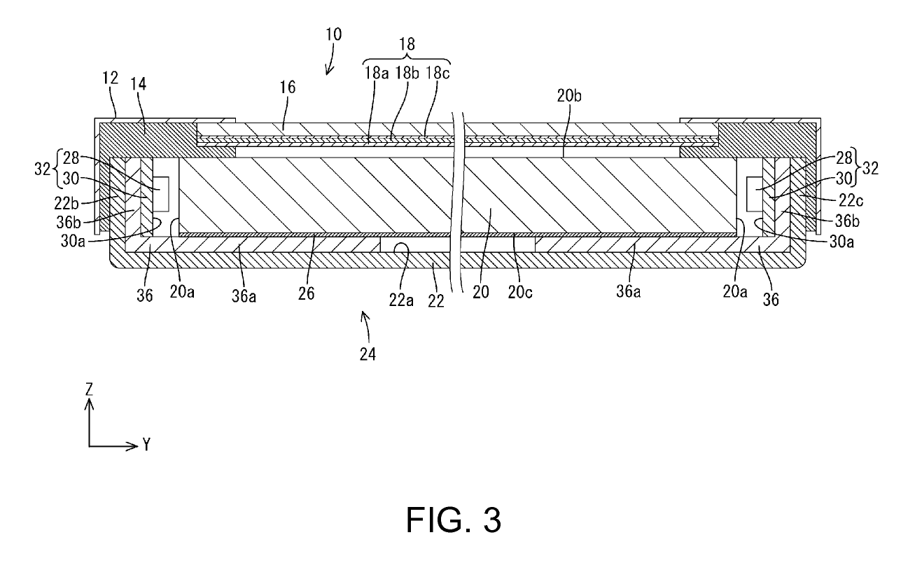

Next, the backlight device 24 is described. As shown in FIGS. 2 and 3, the backlight device 24 includes an approximately box-shaped chassis 22 (one example of an abutting member) that is open on the front side (the light-emitting side, the liquid crystal panel 16 side) and a frame 14 disposed on the front side of the chassis 22, and an optical member 18 disposed to cover the opening of the frame 14. Furthermore, the chassis 22 houses a pair of heat-dissipating members 36 and 36 (one example of abutting members), LED (light emitting diode) units 32, a reflective sheet 26, and a light guide plate 20. Both side faces (light-receiving faces) 20a on the long sides of the light guide plate 20 are disposed so as to face the respective LED units 32 and guide the light emitted from the LED units 32 towards the liquid crystal panel 16. The optical member 18 is placed on the front side of the light guide plate 20. The backlight device 24 of the present embodiment uses the so-called edge-lit method, in which the light guide plate 20 and the optical member 18 are disposed directly below the liquid crystal panel 16, and the LED units 32, which are the light sources, are disposed on the side edges of the light guide plate 20. Each component of the backlight device 24 is described in detail below.

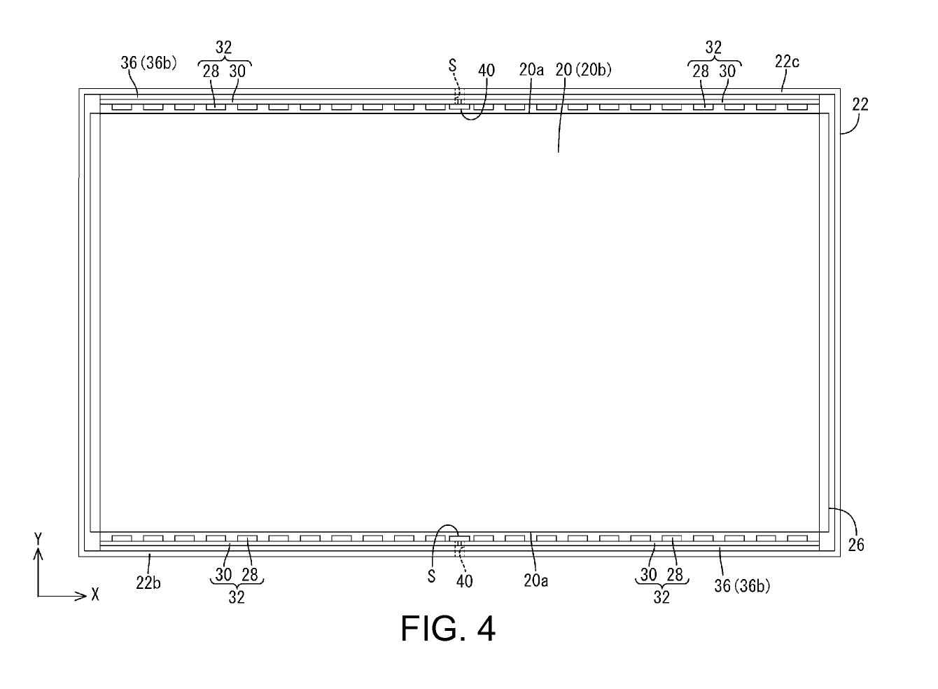

The chassis 22 is made of a metal plate such as an aluminum plate or an electro-galvanized cold-rolled steel (SECC), for example. As shown in FIG. 2 or FIG. 4, the chassis 22 is constituted by a bottom plate 22a having a horizontally-long quadrangular shape similar to the liquid crystal panel 16, side walls 22b and 22c that rise from the respective outer edges of both of the long sides of the bottom plate 22a, and side walls that rise from the respective outer edges of both of the short sides of the bottom plate 22a. The space in the chassis 22 between the LED units 32 is the space for housing the light guide plate 20 described later. The long side direction of the chassis 22 (the bottom plate 22a) corresponds to the X axis direction (horizontal direction), the short side direction to the Y axis direction (vertical direction). The bottom plate 22a extends along the light guide plate 20 and the reflective sheet 26 housed inside the chassis 22 and supports the light guide plate 20 and the reflective sheet 26 from the back side. A control substrate (not shown) for providing a signal for driving a liquid crystal panel 16 is disposed on the outer back side of the bottom plate 22a. In a manner similar to the control substrate described above, other substrates such as an LED driver circuit substrate (not shown) that provides driving power to the LED units 32 are attached to the bottom plate 22a.

The frame 14 is made of a synthetic resin such as plastic and, as shown in FIGS. 2 and 3, is composed of a part that is parallel to the optical member 18 and the light guide plate 20 (the liquid crystal panel 16) and has an approximately frame-like shape in a plan view, and a part that protrudes toward the back side from the periphery of the frame and has an approximately short tube-like shape. The part of the frame 14 that has an approximately frame-like shape extends along the periphery of the light guide plate 20 and can cover from the front side almost the entire periphery of the optical member 18 and the light guide plate 20 disposed on the back side of the frame. At the same time, the part of the frame 14 having an approximately frame-like shape can receive (support) from the back side almost the entire periphery of the optical member 18 disposed on the front side. In other words, the part of the frame 14 having an approximately frame-like shape is interposed between the optical member 18 and the light guide plate 20. Also, one of the long sides of the part of the frame 14 having an approximately frame-like shape collectively covers from the front side the edge of the light guide plate 20 on the side of the light-receiving face 20a and the LED units 32. The part of the frame 14 having an approximately short tube-like shape is attached by being appended to the outer surface of the side walls 22b and 22c of the chassis 22. The outer surface of the portion described above is disposed as to abut the inner surface of the tube-like surface of the bezel 12 described above.

The optical member 18 is constituted by stacking a diffusion sheet 18a, a lens sheet 18b, and a reflective polarizing plate 18c in this order from the light guide plate 20 side. The diffusion sheet 18a, the lens sheet 18b, and the reflective polarizing plate 18c change the light emitted from the LED units 32 and transmitted through the light guide plate 20 into planar light. The liquid crystal panel 16 is disposed on the upper side of the reflective polarizing plate 18d, and the optical member 18 is disposed in a stable manner being sandwiched between the frame 14 and the liquid crystal panel 16. In short, the optical member 18 is slightly larger than the inner edges of the frame 14 and disposed on the front surface of the inner edges thereof. Thus, as shown in the cross-sectional view in FIG. 3, the frame 14 separates the space formed between LEDs 28 and the light guide plate 20 from the edge of the optical member 18.

The light guide plate 20 is made of a synthetic resin (an acrylic resin such as PMMA or a polycarbonate, for example) that has a refractive index that is sufficiently higher than that of air and almost completely transparent (has excellent light transmission characteristics). As shown in FIG. 2, the light guide plate 20 has a horizontally-long quadrangular shape in a plan view, in a manner similar to the liquid crystal panel 16 and the chassis 22, and is shaped like a plate that is thicker than the optical sheet 18. The long side direction of the surface of the light guide plate 20 corresponds to the X axis direction, the short side to the Y axis direction, respectively, and the plate thickness direction intersecting with the surface corresponds to the Z axis direction. Each of the side faces on the long side of the light guide plate 20 is the light-receiving face 20a that receives the light emitted from the LEDs 28.

As shown in FIGS. 2 to 4, the light guide plate 20 is disposed such that the light-receiving face 20a faces the LED units 32, the light-exiting face 20b, which is the primary surface (the front surface), faces the optical sheet 18, and an opposite surface 20c, which is the surface opposite to a light-exiting face 20b (the back surface), faces the reflective sheet 26. The light guide plate 20 is supported by a bottom face portion 36a of the heat-dissipating member 36 (described later) of the chassis 22 via the reflective sheet 26. In other words, the direction in which the light guide plate 20 aligns with the LED units 32 corresponds to the Y axis direction, and the direction in which the light guide plate 20 aligns with the optical sheet 18 and the reflective sheet 26 corresponds to the Z axis direction. The light guide plate 20 has a function of receiving the light emitted along the Y axis direction from the LED units 32 from the light-receiving face 20a, causing the light to travel toward the optical sheet 18 while propagating the light internally, and letting the light exit from the light-exiting face 20b.

The reflective sheet 26 has the shape of a rectangular sheet, is made of a synthetic resin, and the surface thereof is white with excellent light-reflecting characteristics. The long side direction of the reflective sheet 26 corresponds to the X axis direction, the short side direction to the Y axis direction, and the reflective sheet 26 is disposed being sandwiched between the opposite surface 20c of the light guide plate 20 and the bottom plate 22a of the chassis 22. The front side of the reflective sheet 26 has a reflective surface, and this reflective surface touches the opposite surface 20c of the light guide plate 20. The reflective sheet 26 can reflect light that has leaked from the LED units 32 or the opposite surface 20c of the light guide plate 20 toward the light-reflecting side of the reflective sheet 26. Also, as shown in FIG. 3, the edges of the reflective sheet 26 on the side of light-receiving face 20a extend until the edges abut the LED substrates 30. Because of this, the light emitted from the LEDs 28 that travels directly toward the reflective sheet 26 can be reflected toward the light-receiving face 20a.

On each of the long sides of the chassis 22, two LED units 32 are disposed in parallel along the long side direction of the chassis 22. Each of the LED units 32 is constituted by the LEDs 28 and the LED substrate 30. Each of the LEDs 28 that constitutes the LED unit 32 is made by sealing an LED chip (not shown) by a resin on a substrate portion that is fixed to the LED substrate 30. The LED chip mounted on the substrate portion has one kind of primary light-emitting wavelength, and specifically, only emits blue light. On the other hand, phosphor that emits a prescribed color when excited by blue light emitted from the LED chip is dispersed in the resin that seals the LED chip, and the LED chip as a whole emits light that is largely white. For the phosphor, a yellow phosphor that emits yellow light, a green phosphor that emits green light, and a red phosphor that emits red light can be combined appropriately for use, or only one of the phosphors can be used, for example. The LEDs 28 are so-called top-emitting type, for which the primary light-emitting face is the surface opposite to the mounting surface 30a of the LED substrate 30 (the surface facing the light-receiving face 20a of the light guide plate 20).

As shown in FIGS. 2 and 4, the LED substrate 30 that constitutes the LED unit 32 has a shape of a narrow plate extending along the long side direction (the X axis direction, the long side direction of the light-receiving face 20a) of the light guide plate 20 and is housed inside the chassis 22 such that the plate surface thereof is parallel to both the X axis direction and the Z axis direction, or in other words, parallel to the light-receiving face 20a of the light guide plate 20. The length in the long side direction (the X axis direction) of each of the LED substrates 30 is about half as long as the length in the long side direction of the light guide plate 20. The LEDs 28 having the configuration described above are mounted on the inner surface of the LED substrate 30, in other words, the surface facing the light guide plate 30 (the surface facing the light guide plate 16), and this surface is the mounting surface 30a. A plurality of the LEDs 28 are disposed on the mounting surface 30a of the LED substrate 30 in a single row (in a straight line) in the length direction (the X axis direction) with a prescribed gap between each of the LEDs. That is, the plurality of the LEDs 28 are disposed intermittently on each of the edges of the longer sides of the backlight device 24 along the long side direction. The interval between the adjacent LEDs 28 along the X axis direction, or in other words the array pitch of the LEDs 28, is approximately the same. The alignment direction of the LEDs 28 corresponds to the long side direction (the X axis direction) of the LED substrate 30. A wiring pattern (not shown) made of metal film (copper foil, for example) is formed on the mounting surface 30a of the LED substrate 30. The wiring pattern extends along the X axis direction and goes across the group of LEDs 28 connecting the adjacent LEDs 28 in series. By connecting to a power supply board via a wiring member such as a connector or a cable, terminals formed at the both ends of the wiring pattern supply driving power to each of the LEDs 28. The LED substrate 30 is attached to the heat-dissipating member 36 described later. The attachment or the like of the LED substrate 30 to the heat-dissipating member 36 is described later in detail.

A pair of heat-dissipating members 36 and 36 is disposed on the long sides of the chassis 22, respectively. Each of the heat-dissipating members 36 is made of metal having excellent thermal conductivity such as aluminum and, as shown in FIG. 3, includes a rising portion 36b to which the LED substrate 30 is attached, and the bottom face portion 36a that touches the bottom plate 22a of the chassis 22. In a cross-sectional view, these two parts together have a bent shape that is approximately in the shape of an “L.” The length of the long side of the heat-dissipating member 36 is approximately the same as that of the light guide plate 20. As shown in FIG. 3, the bottom face portion 36a that constitutes the heat-dissipating member 36 has a plate-like shape that is parallel to the bottom plate 22a of the chassis 22, and the long side direction thereof corresponds to the X axis direction, the short side direction to the Y axis direction, and the thickness direction to the Z axis direction, respectively. The bottom face portion 36a is formed as to protrude from an edge on the back side of the rising portion 36b (the edge on the side of the chassis 22) towards the inner side along the Y axis direction, in other words, towards the middle of the light guide plate 20. A large part of this section corresponds to the back side of the light guide plate 20 and is located on the back side of the reflective sheet 26. In other words, a large part of the bottom face portion 36a is sandwiched (interposed) between the reflective sheet 26 and the chassis 22. The entire back surface of the bottom section 36a, or in other words the surface facing the chassis 22, touches the bottom plate 22a of the chassis 22. In this configuration, the heat conducted from the LEDs 28 to the heat-dissipating member 36 is efficiently dissipated from the bottom face portion 36a toward the bottom plate 22a of the chassis 22.

The rising portion 36b that constitutes the heat-dissipating member 36 rises from the edge of the outer side of the bottom face portion 36a (the side opposite to the light guide plate 20) perpendicularly to the bottom face portion 36a. The bottom face portion 36a has a plate-like shape that runs parallel to the surface of the LED substrate 30 and the light-receiving face 20a of the light guide plate 20, and the long side direction thereof corresponds to the X axis direction, the short side direction to the Z axis direction, and the thickness direction to the Y axis direction, respectively. The LED substrate 30 touches and is attached with double-sided tape (not shown) to the inner surface of the rising portion 36b, or in other words the surface facing the light guide plate 20. The length of the long side of the rising portion 36b is approximately two times longer than that of the LED substrate 30, and the length of the short side of the rising portion 36b is approximately the same as that of the LED substrate 30. Of the rising portion 36b, the surface on the outer side touches the side walls 22b and 22c of the chassis 22. The bottom face portion 36a of the heat-dissipating member 36 is fastened with a screw to the bottom plate 22a of the chassis 22 and thereby fixed to the chassis 22.

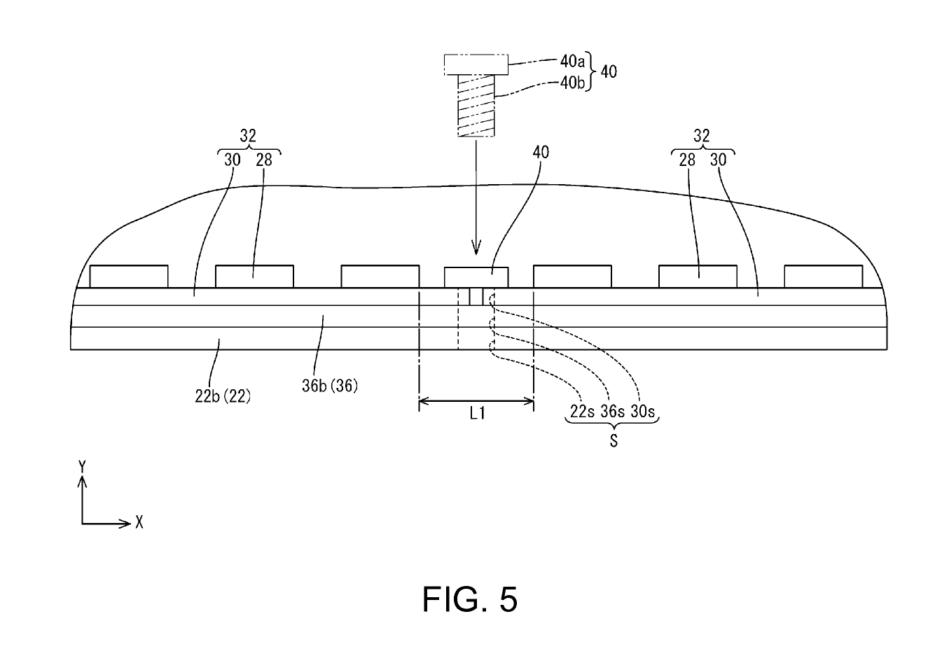

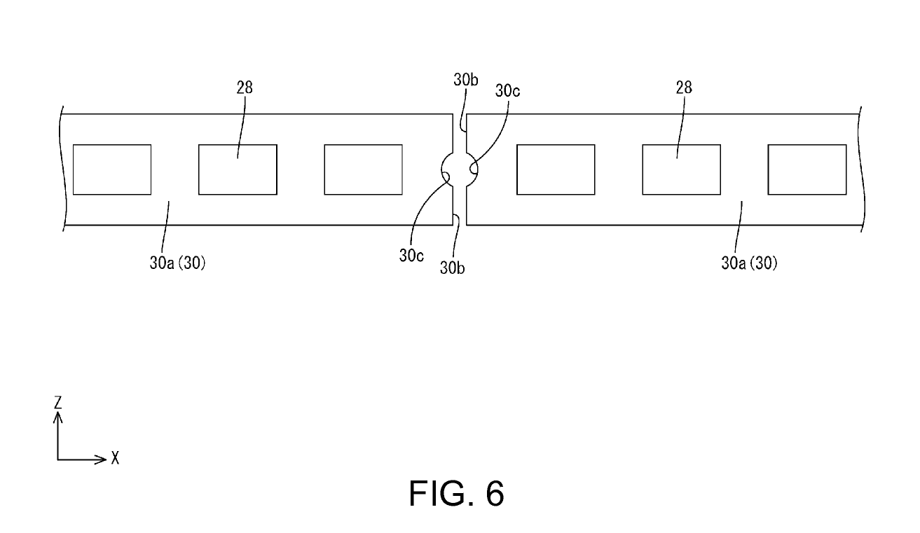

Next, the configuration of cutout portions 30c disposed on the LED substrates 30 and the attachment thereof to the heat-dissipating member 36 of the LED substrates 30 and to the chassis 22 are described. As shown in FIGS. 4 and 6, the two LED substrates 30 disposed in parallel along the long side direction of the chassis 22 are positioned close together such that their positions along the Z direction are aligned. As shown in FIG. 6, out of both short-side edges of each of the LED substrates 30, each inner edge 30b, or in other words the edge facing the adjacent LED substrate 30 (referred to as the inner edge 30b below) is provided with the semicircular cutout portion 30c. The cutout portions 30c are provided such that they are symmetrical in shape and size about the gap between the adjacent LED substrates 30. By putting the adjacent LED substrates 30 close together, the two cutout portions 30c provided in each of the LED substrates 30 become adjacent to one another. As a result, a gap 30s having an approximately circular shape is formed in the gap between the adjacent LED substrates 30 (see FIG. 5). Also, out of both short-side edges of each of the LED substrates 30, the outer edges are provided with a connector (not shown) for providing driving power to each of the LEDs 28.

As shown in FIG. 5, a heat-dissipating member side through-hole 36s, which penetrates the rising portion 36b and has approximately the same shape and size as the gap 30s, is provided in the location where the rising portion 36b of the heat-dissipating member 36 overlaps with the gap 30s. Furthermore, a chassis side through-hole 22s, which penetrates the side walls 22b and 22c and has approximately the same shape and size as the gap 30s, is provided in the location where the side walls 22b and 22c of the chassis 22 overlap with the gap 30s and the heat-dissipating member side through-hole 36s. A screw fastening hole S is formed by the gap 30s, the heat-dissipating member side through-hole 36s, and the chassis side through-hole 22s. A fixing screw 40 (one example of a fixing member) is inserted in the screw fastening hole S.

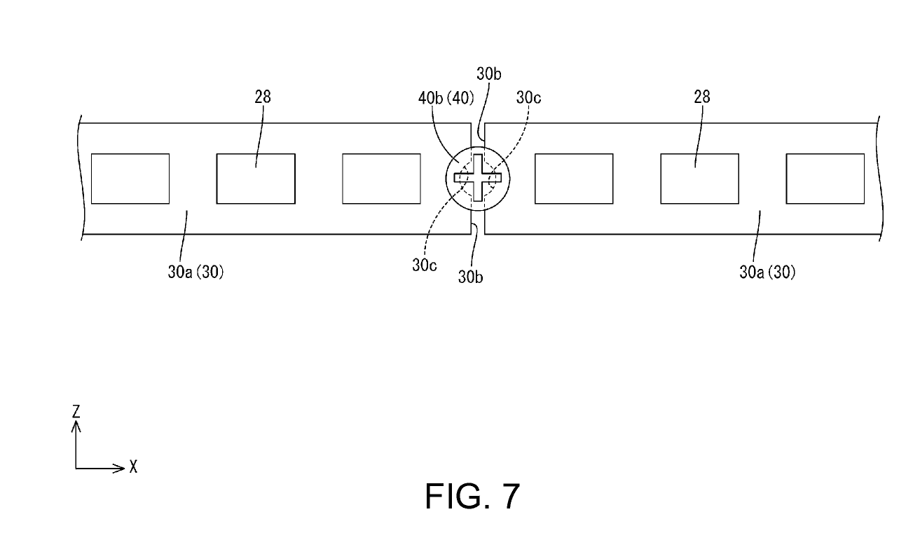

As shown in FIG. 5, the fixing screw 40 that is inserted in the screw fastening hole S is constituted by a screw head 40a and a screw shaft 40b. The screw shaft 40b has a pillar-like shape and is inserted into the screw fastening hole S such that the outer surface thereof touches each of the adjacent cutout portions 30c in the gap between the adjacent LED substrates 30 (see FIGS. 5 and 7). The screw head 40a has a disk-like shape that has a diameter larger than the screw shaft 40b. In the gap between the adjacent LED substrates 30 positioned close together, the screw head 40a covers the inner edges 30b of the mounting surface 30a around the gap S in each of the LED substrates 30. The outer surface of the screw shaft 40b of the fixing screw 40 abuts the inner surface of each of the adjacent cutout portions 30c; thus, movement of each of the adjacent LED substrates 30 in the surface direction thereof (Z-X planar direction) is constrained. Also, because the screw head 40a of the fixing screw 40 abuts the inner edges 30b of the mounting surface 30a around the gap S in each of the LED substrates 30, movement of each of the adjacent LED substrates 30 in the thickness direction (Y axis direction) is constrained. Thus, the fixing screw 40 fixes both of the adjacent LED substrates 30 positioned close together to the heat-dissipating member 36 and the chassis 22 in the region around the gap 30s (see FIGS. 5 and 7).

The above is the configuration of the backlight device 24 according to the present embodiment. Next, the effects of the embodiment are described. In the present embodiment, the gap 30s is formed by the cutout portions 30c provided on each of the inner edges 30b of the adjacent LED substrates 30 positioned close together along the long side direction of the chassis 22 (X axis direction). When providing a screw hole for inserting the fixing screw 40 in each of the inner edges 30b of the adjacent LED substrates 30, the distance between the LEDs 28 between adjacent LED substrates 30 increases because in each of the LED substrates 30 space for providing a screw hole needs to be secured in the region between the inner edges 30b and the LEDs 28 disposed near the edges. The increase in the gap results in a reduced brightness in the gap between the adjacent LED substrates 30. Also, when providing a screw hole for inserting the fixing screw 40 near the middle of the long side direction of each of the adjacent LED substrates 30, the distance between the adjacent LEDs 28 sandwiching the screw hole increases, and the brightness between both of the LEDs 28 is reduced.

In contrast, in the present embodiment, by having the single fixing screw 40 inserted through the gap 30s formed by two of the adjacent cutout portions 30c, the single fixing screw 40 fixes each of the adjacent LED substrates 30 to the heat-dissipating member 36 and the chassis 22. As a result, compared to when providing a screw hole for inserting the fixing screw 40 in each of the inner edges 30b of the adjacent LED substrate 30, in each of the LED substrates 30, the distance between the inner edges 30b and the LEDs 28 disposed near the edge is reduced. Because of this, in the gap between the adjacent LED substrates 30, a distance L1 (see FIG. 5) between the LEDs 28 disposed near the inner edges 30b of each of the LED substrates 30 is reduced. As a result, in the gap between the adjacent LED substrates 30, the reduction in brightness in the gap between the adjacent LED substrates 30 due to the increase in the distance between the LEDs 28 is either prevented or mitigated, and favorable brightness in the gap between the adjacent LED substrates 30 is maintained.

As described above, in the backlight device 24 according to the present embodiment, because the screw shaft 40b of the fixing screw 40 is inserted through the cutout portions 30c provided in the inner edges 30b of the LED substrates 30 and fixed to the heat-dissipating member 36 and the chassis 22, and because the screw head 40a of the fixing screw 40 touches the respective mounting surfaces 30a of the adjacent LED substrates 30, the single fixing screw 40 can fix the adjacent LED substrates 30 to the heat-dissipating member 36 and the chassis 22. This makes it possible to reduce the space needed for providing the fixing screw 40, compared to when providing the fixing screw 40 near the inner edges 30b of each of the adjacent LED substrates 30, for example. As a result, in the backlight device 24 according to the present embodiment, adequate space for providing the LEDs 28 in the region between the adjacent LED substrates 30 can be secured, and the reduction in brightness in the gap between the adjacent LED substrates 30 can be either prevented or mitigated using a simple configuration.

In the present embodiment, the outer surface of the screw shaft 40b of the fixing screw 40 touches the inner surface of each of the cutout potions 30b. For this reason, in the process of manufacturing the backlight device 24, the fixing screw 40 can be used to fix the position of the LED substrates 30 to align with the surface direction (the X-Y plane) of the heat-dissipating member 36 and the chassis 22.

In the present embodiment, the cutout portion 30c is provided on each of the inner edges 30b in the adjacent LED substrates 30, and the shape and size of two of the adjacent cutout portions 30c are symmetrical about the gap between the adjacent LED substrates 30. In this configuration, the forces applied by the fixing screw 40 to fix each of the adjacent LED substrates 30 become equal. In other words, the fixing screw 40 allows each of the LED substrates 30 adjacent to one another to be held with equal force, without one side being held with greater force than the other.

### Embodiment 2

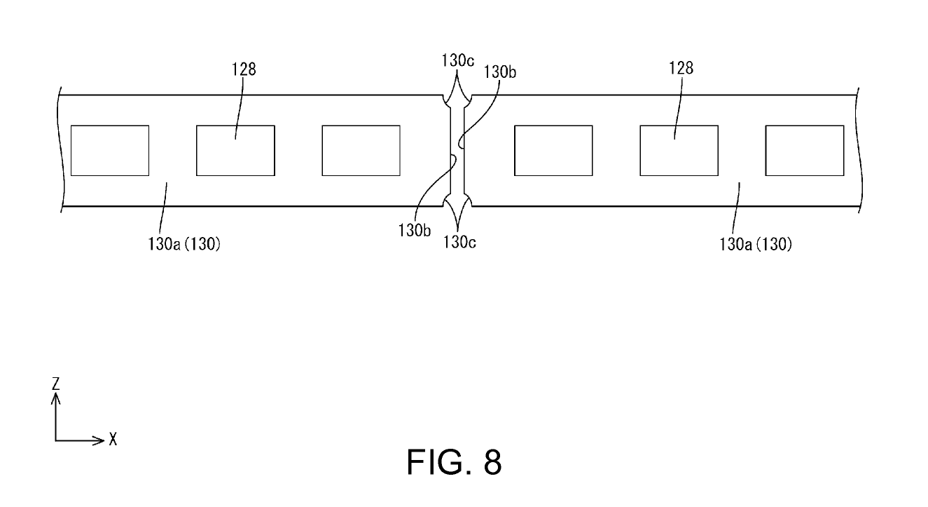

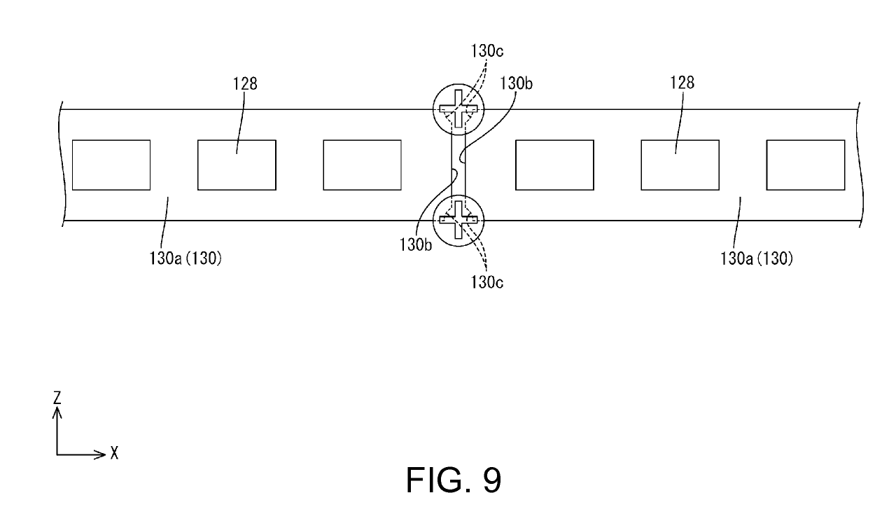

Embodiment 2 is described with reference to the drawings. In Embodiment 2, the number and shape of cutout portions 130c provided on inner edges 130b of each LED substrate 130 differ from those in Embodiment 1. Other configurations are similar to those of Embodiment 1; thus, the descriptions of the configurations, operation, and effects are omitted. Parts in FIGS. 8 and 9 that have 100 added to the reference characters of FIGS. 6 and 7 respectively are the same as those parts described in Embodiment 1.

As shown in FIG. 8, in the gap between the adjacent LED substrates 130 of a backlight device according to Embodiment 2, two cutout portions 130c are provided on the inner edges 130b of each of the LED substrates 130 along the short side direction (the Z axis direction) of the LED substrates 130. Specifically, the cutout portions 130c are provided on both ends of the inner edges 130b. Thus, in the gap between the adjacent LED substrates 130, at both ends of each of the inner edges 130b, the two cutout portions 130c are positioned close together. Each of the cutout portions 130c has a quarter-circle-like shape, and a semicircular gap is formed by positioning two of the cutout portions 130c close together. In other words, in the present embodiment, in the gap between the adjacent LED substrates 130, two substrate side through-holes are formed in parallel along the short side direction of the LED substrates 130 (Z axis direction).

In the present embodiment, as shown in FIG. 9, a fixing screw 140 is inserted in each of the two gaps described above. Both of the adjacent LED substrates 130 positioned close together are fixed to a heat-dissipating member and a chassis by the two fixing screws 140 inserted in the inner edges 130b of the LED substrates 130. Even in this configuration, the space for providing the fixing screws 140 in the gap between the adjacent LED substrates 130 can be reduced compared to when providing a screw hole for inserting the fixing screw 140 in each of the inner edges 130b of the adjacent LED substrates 130. Thus, the reduction in brightness in the gap between the adjacent LED substrates 130 can be either prevented or mitigated. Furthermore, in the present embodiment, because the two fixing screws 140 are used to fix both of the adjacent LED substrates 130 to the heat-dissipating member and chassis, both of the adjacent LED substrates 130 can be fixed to the heat-dissipating member and chassis more firmly than in Embodiment 1.

### Embodiment 3

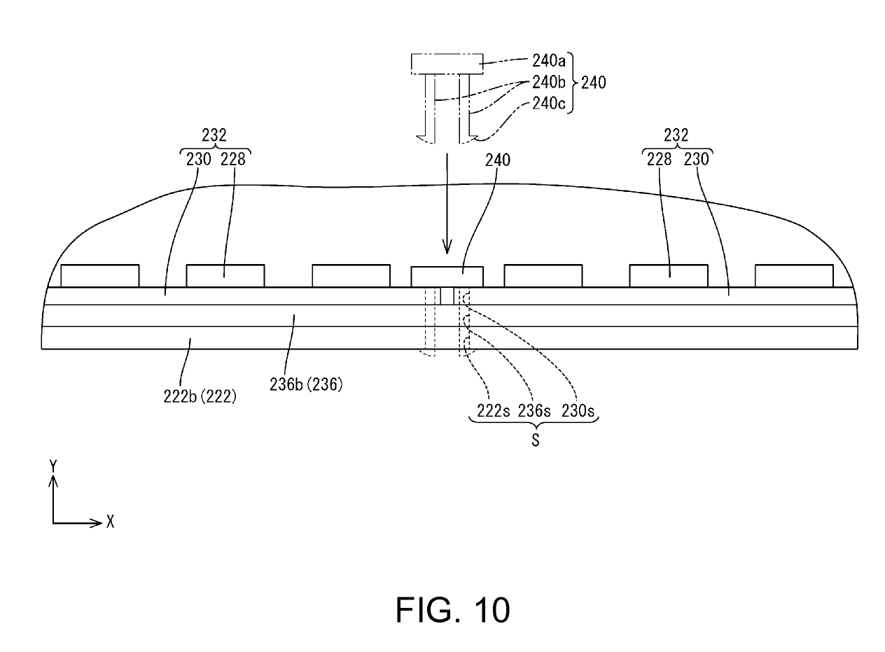

Embodiment 3 is described with reference to the drawings. In Embodiment 3, the configuration of a fixing screw 240 and the shape of cutout portions 230c provided on inner edges 230b of each LED substrate 230 differ from those in Embodiment 1. Other configurations are similar to those of Embodiment 1; thus, the descriptions of the configurations, operation, and effects are omitted. Parts in FIGS. 10, 11, and 12 that have 200 added to the reference characters of FIGS. 5, 6, and 7 are the same as those parts described in Embodiment 1.

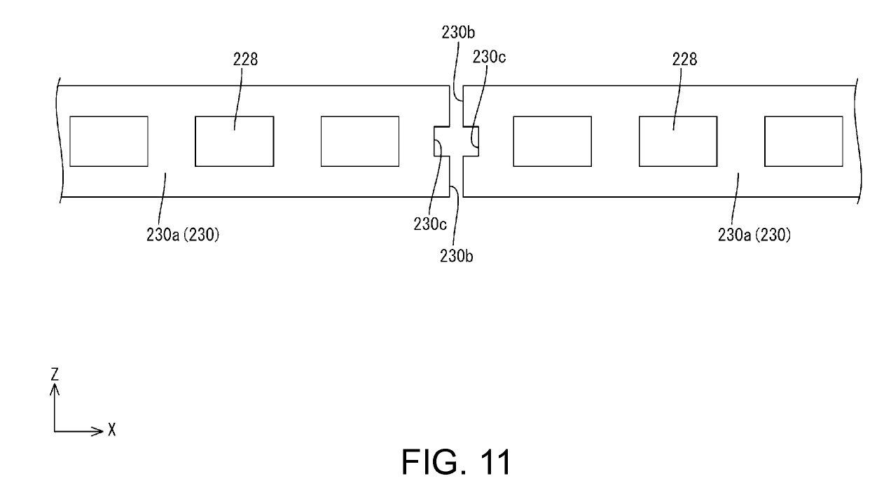

In a backlight device according to Embodiment 3, as shown in FIG. 11, the cutout portions 230c having a recessed shape are provided in the inner edges 230b of each of the LED substrates 230 facing one another. The cutout portions 230c are symmetrical in both shape and size about the gap between the adjacent LED substrates 230. By having the adjacent LED substrates 230 positioned close together, the two cutout portions 230c provided in each of the LED substrates 230 become adjacent to one another. As a result, as shown in FIG. 11, a gap 230s having an approximately rectangular shape is formed between the adjacent LED substrates 230 (See FIG. 10).

As shown in FIG. 10, a heat-dissipating member side through-hole 236s, which penetrates a rising portion 236b and has approximately the same shape and size as the gap 230s, is located where the rising portion 236b of the heat-dissipating member 236 overlaps with the gap 230s. Furthermore, a chassis side through-hole 222s, which penetrates the side walls 222b and has approximately the same shape and size as the gap 230s, is located where the side walls 222b of the chassis 222 overlap with the gap 230s and the heat-dissipating member side through-hole 236s. A screw fastening hole S is formed by the gap 230s, the heat-dissipating member side through-hole 236s, and the chassis side through-hole 222s. A resin clip 240 is inserted into and fixed to the screw fastening hole S.

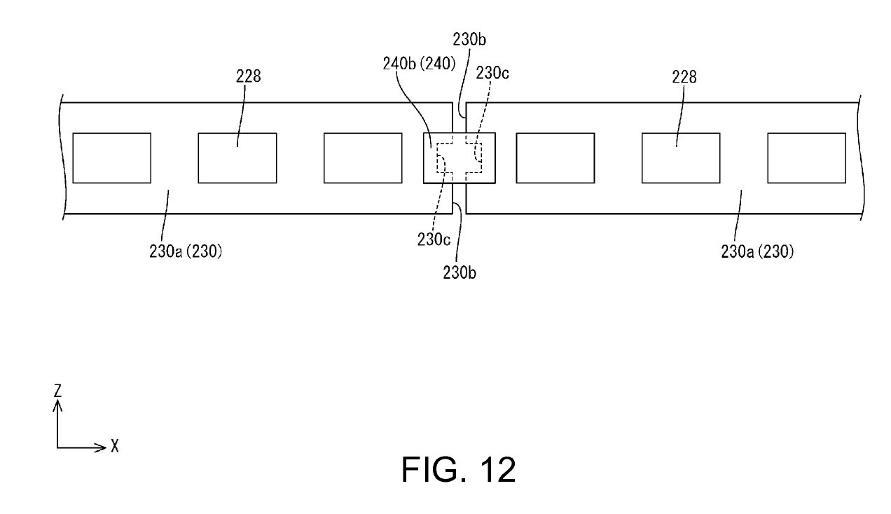

As shown in FIG. 10, the resin clip 240 inserted into the screw fastening hole S has a clip-like shape, and is made of a clip head 240a, two clip legs 240b, and a clip fastening portion 240c. Each of the clip legs 240b forms the leg of the resin clip 240 and is inserted into the screw fastening hole S so that the outer surface thereof touches each of the adjacent cutout portions 230c (See FIGS. 10 and 12). The clip head 240a has a plate-like shape bigger than the opening formed by the gap 230s. In the gap between the adjacent LED substrates 230 positioned close together, the clip head 240a covers the inner edges 230b of the mounting surface 230a around the gap 230s in each of the LED substrates 230. The clip fastening portion 240c is provided on the tip opposite to the side the clip head 240a is connected to the clip leg 240b and placed at a location where it has penetrated through the screw fastening hole S. The clip fastening portion 240c is warped on the outer side of the side walls 222b of the chassis 222 and touches the outer surface of the side walls 222b of the chassis 222. In this way, the screw fastening hole S fastens the resin clip 240. Because of its clip-like shape, the two clip legs 240b of the resin clip 240 can be made to approach each other, and the two clip legs 240b and the clip fastening portion 240c can be inserted into the screw fastening hole S. In the present embodiment, using the resin clip 240, which is made of resin and has a clip-like shape, instead of a metal screw as in Embodiments 1 and 2, can reduce the weight of the backlight device.

### Embodiment 4

Embodiment 4 is described with reference to the drawings. Embodiment 4 differs from Embodiment 1 in that a liquid crystal display device 310 lacks a cabinet. Other configurations are similar to the liquid crystal display device 10 having a cabinet according to Embodiment 1; thus, the description thereof is omitted.

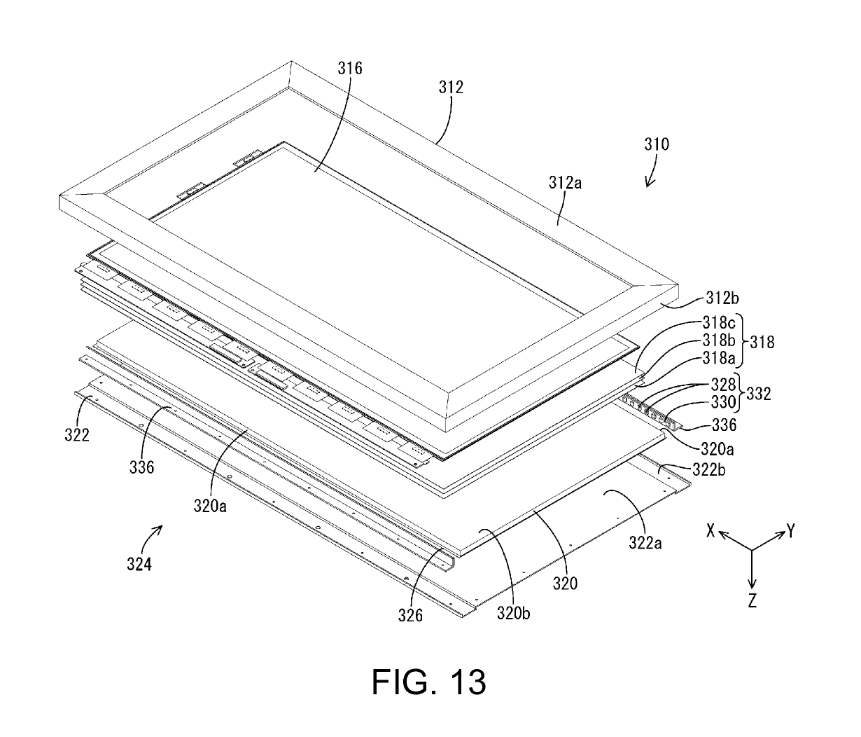

As shown in FIG. 13, the main constituting components of the liquid crystal display device 310 according to Embodiment 4 are housed in the housing space formed between a frame 312 that constitutes the front exterior and the chassis 322 that constitutes the rear exterior. The main components housed inside the frame and chassis include at least a display panel 316, an optical member 318, a light guide plate 320, an LED unit 332, and a heat-dissipating member 336. Of these, the liquid crystal panel 316, the optical member 318, and the light guide plate 320 are stacked on one another and held by being sandwiched by the frame 312 on the front side thereof and the chassis 322 on the back side thereof. A bottom face portion 336a of the heat-dissipating member according to the present embodiment extends in the direction opposite to that in Embodiment 1. In other words, the bottom face portion 336a protrudes from the edge on the back side (the edge on the chassis 322 side) of a rising member 336b to the outer side in the Y axis direction, or in short, toward the outer side of the light guide plate 320.

The frame 312 includes a frame section 312a having a frame-like shape and the surface thereof is parallel to the display surface of the liquid crystal panel 316, and a cylindrical portion 312b protruding from the edges of the frame section 312a toward the back side (the chassis 322 side) in a cylinder-like manner. The chassis includes the bottom face portion 322a having a horizontally-long quadrangular shape in a manner similar to the light guide plate 320, and a pair of LED housing sections 322b that house the LED units 332 and the heat-dissipating member 336 and protrude from each of the long-side edges of the bottom face portion 322a toward the back side in a step-like manner, respectively.

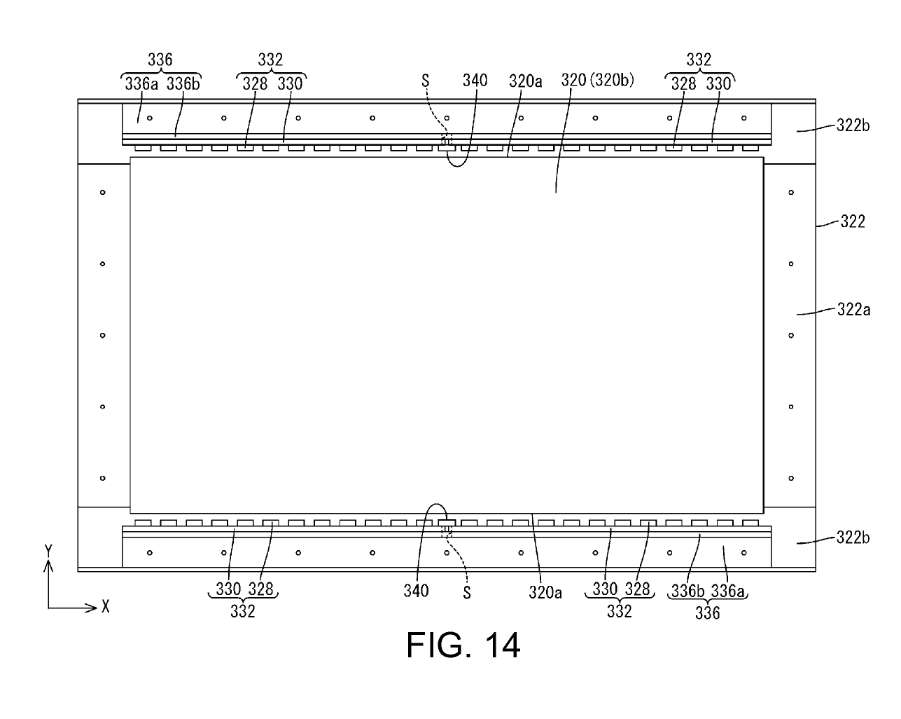

As shown in FIG. 14, the present embodiment also includes a single screw fastening hole S in the gap between adjacent LED substrates 330. By having the fixing screw 340 be inserted into the screw fastening hole S, the single fixing screw 340 fixes each of the adjacent LED substrates 330 to the heat-dissipating member 336 and the chassis 322. In this configuration, the space for disposing the fixing screw 340 in each of the gaps between the adjacent LED substrates 330 can be reduced compared to when providing a screw hole for inserting the fixing screw 340 in each of the inner edges 330b of the adjacent LED substrates 330. As a result, the reduction in brightness in the gap between adjacent LED substrates 330 can be either prevented or mitigated using a simple configuration.

### Embodiment 5

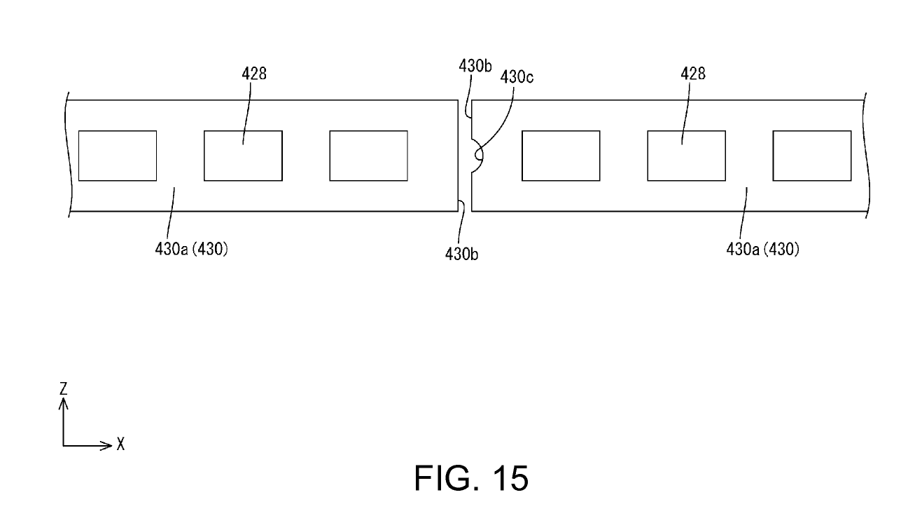

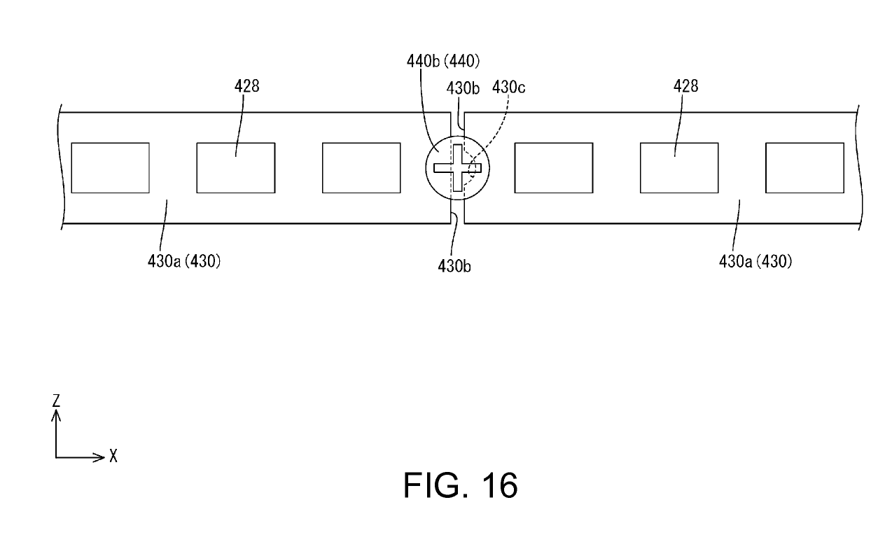

Embodiment 5 is described with reference to the drawings. In Embodiment 5, the number of cutout portions 430c provided on inner edges 430b of each LED substrate 430 differs from that in Embodiment 1. Other configurations are similar to those of Embodiment 1; thus, the descriptions of the configurations, operation, and effects are omitted. Parts in FIGS. 15 and 16 that have 400 added to the reference characters of FIGS. 6 and 7 are the same as these parts described in Embodiment 1.

In a backlight device according to Embodiment 5, as shown in FIG. 15, of the adjacent LED substrates 430, the cutout portion 430c is provided on the inner edge 430b of only one of the adjacent LED substrates 430. The shape, position, and the like of the cutout portion 430c are similar to the cutout portion 30c described in Embodiment 1. As shown in FIG. 16, a fixing screw 440 is inserted into a gap formed by the single cutout portion 430c in the gap between the adjacent LED substrates 430.

Even in this configuration, the space for providing the fixing screw 440 in the gap between the adjacent LED substrates 430 can be reduced compared to when providing a screw hole for inserting the fixing screw 440 in each of the inner edges 430b of the adjacent LED substrates 430. As a result, the reduction in brightness in the gap between adjacent LED substrates 430 can be either prevented or mitigated.

### Embodiment 6

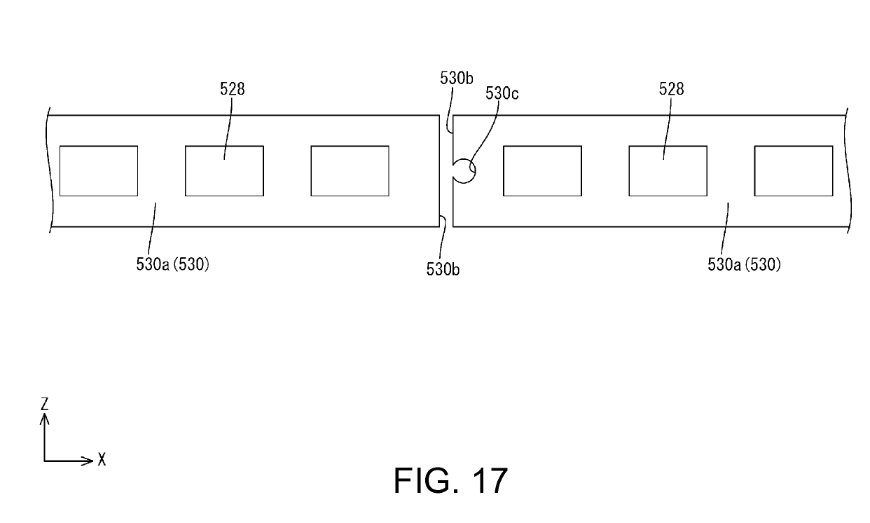

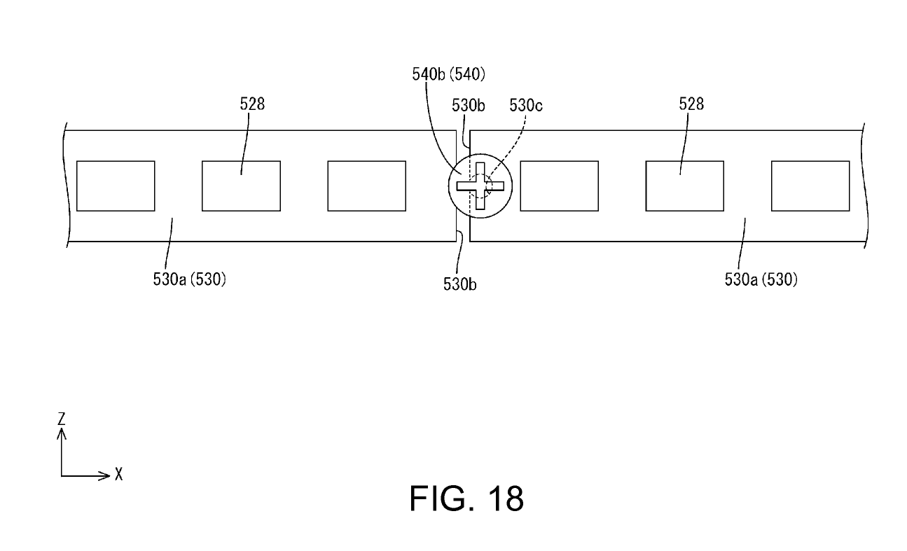

Embodiment 6 is described with reference to the drawings. In Embodiment 6, the shape of a cutout portion 530c provided on an inner edge 530b of one of adjacent LED substrates 530 differs from that in Embodiment 5. Other configurations are similar to those of Embodiment 5; thus, the descriptions of the configurations, operation, and effects are omitted. Parts in FIGS. 17 and 18 that have 500 added to the reference characters of FIGS. 6 and 7 are the same as these parts described in Embodiments 1 and 5.

As shown in FIG. 17, in a backlight device according to Embodiment 6, the cutout portion 530c is provided in the inner edge 530b of only one of the adjacent LED substrates 530 in a manner similar to Embodiment 5. In a plan view, the cutout portion 530c almost has an exactly circular shape. As shown in FIG. 18, a fixing screw 540 is inserted into a gap formed by the single cutout portion 530c in the gap between the adjacent LED substrates 530.

Even though the fixing screw 540 is provided more on the side of the LED substrate 530 on which the cutout portion 530c is provided, part of a screw head 540a also touches a mounting surface 530a of the LED substrate 530 on which the cutout portion 530c is not provided. In this configuration, compared to when providing a screw hole for inserting the fixing screw 540 on each of the inner edges 530b of the adjacent LED substrates 530, the space for providing the fixing screw 540 in the gap between the adjacent LED substrates 530 can be reduced while fixing the adjacent LED substrates 530 to a heat-dissipating member and a chassis with the single fixing screw 540. As a result, the reduction in brightness in the gap between adjacent LED substrates 530 can be either prevented or restrained using a simple configuration.

Modification examples of the respective embodiments mentioned above are described below.

(1) Although the respective embodiments described above used as an example a configuration in which two LED substrates are arranged in parallel along the long side direction of the chassis, the number of LED substrates arranged in parallel is not limited to two. Three or more LED substrates may be arranged in parallel. Such a configuration may be used as long as a cutout portion into which a fixing screw is inserted is provided at least on one of the inner edges of adjacent LED substrates.

(2) Although the respective embodiments described above used an example in which a fixing screw or a resin clip was used as a fixing member, the configuration of the fixing member is not limited to this example.

(3) Although Embodiments 1 to 4 described above used as an example a configuration in which the two adjacent cutout portions are symmetrical in shape and size about the gap between adjacent LED substrates, when providing two adjacent cutout portions, the two adjacent cutout portions may be asymmetrical in shape and size.

(4) In addition to the respective embodiments described above, the shape, configuration, number, and the like of the cutout portions provided on the inner edges of LED substrates can be modified appropriately.

(5) In addition to the respective embodiments described above, the shape, configuration, number, and the like of a fixing member can be modified appropriately.

(6) Although the respective embodiments described above used as an example an edge-lit backlight device, a direct-lit backlight device can also be used in the present invention.

(7) Although the respective embodiments described above used as an example a liquid crystal display device using a liquid crystal panel as a display panel, the present invention is also applicable to a display device that uses another type of display panel.

The embodiments of the present invention were described above in detail, but these are only examples, and do not limit the scope as defined by the claims. The technical scope defined by the claims includes various modifications of the specific examples described above.

### DESCRIPTION OF REFERENCE CHARACTERS

TV television receiver
Ca, Cb cabinet
T tuner
S stand
10, 310 liquid crystal display device
12 bezel
14, 312 frame
16, 316 liquid crystal panel
18, 318 optical member
20, 320 light guide plate
20a, 320 light-receiving face
20b, 320b light-exiting face
22, 222, 322 chassis
24, 324 backlight device
26, 326 reflective sheet
28, 128, 228, 328, 428, 528 LED
30, 130, 230, 330, 430, 530 LED substrate
30b, 130b, 230b, 330b, 430b, 530b inner edge
30c, 130c, 230c, 330c, 430c, 530c cutout portion
30s, 230s gap
32, 132, 232, 332 LED unit
36, 236, 336 heat-dissipating member
40, 140, 340 fixing screw
240 resin clip
S screw fastening hole

1. An illumination device, comprising:
a plurality of light source substrates having a rectangular plate shape, said light source substrates being arranged in a row along a long side direction thereof, and each of said light source substrates having a plurality of light sources on one surface thereof; and
an abutting member abutting another surface of each of said light source substrates;
wherein, for at least one pair of said light source substrates that are adjacent to each other, a cutout portion is provided in at least one of short sides, facing each other, of said light source substrates that are adjacent to each other, and
wherein a fixing member is provided to fix said at least one pair of said light source substrates that are adjacent to each other to the abutting member, the fixing member having a portion that goes though said cutout portion from said one surface and that is fixed to said abutting member and another portion that abuts said one surface of each of said light source substrates that are adjacent to each other.

2. The illumination device according to claim 1, wherein said cutout portion is provided in each of the short sides, facing each other, of said light source substrates that are adjacent to each other, and said light source substrates that are adjacent to each other are disposed such that said cutout portions in the respective short sides face each other.

3. The illumination device according to claim 2, wherein said cutout portions are symmetrical in shape and size about a gap between said light source substrates that are adjacent to each other.

4. The illumination device according to claim 1, wherein said fixing member abuts an inner surface of said cutout portion.

5. The illumination device according to claim 1, wherein the cutout portion is provided in a plurality in said at least one of the short sides, facing each other, of said light source substrates that are adjacent to each other, and the fixing member is provided in a plurality to fix each of said light source substrates that are adjacent to each other to said abutting member.

6. The illumination device according to claim 1, wherein said fixing member is a resin clip.

7. The illumination device according to claim 1, wherein said abutting member is a heat-dissipating member having heat-dissipating characteristics.

8. The illumination device according to claim 1, wherein said abutting member is a chassis, a part of which is a bottom plate.

9. A display device comprising:
said illumination device according to claim 1; and
a display panel that performs display using light from said illumination device.

10. The display device according to claim 9, wherein said display panel is a liquid crystal panel that uses liquid crystal.

11. A television receiver device, comprising: said display device according to claim 9.

12. The illumination device according to claim 1, wherein the cutout portion is provided in a plurality in each of the short sides, facing each other, of the light source substrates that are adjacent to each other, and the fixing member is provided in a plurality to fix each of said light source substrates that are adjacent to each other to said abutting member.

13. The illumination device according to claim 1, wherein, for every pair of said light source substrates that are adjacent to each other, said cutout portion is provided in at least one of short sides, facing each other, of said pair of said light source substrates that are adjacent to each other, and
wherein, for said every pair of said light source substrates that are adjacent to each other, said fixing member is provided to fix said pair of said light source substrates to the abutting member.
